(19) United States
(12) Patent Application Publication
(10) Pub. No.: US 2017/0289808 A1
(43) Pub. Date: Oct. 5, 2017

(54) METHOD AND DEVICE FOR INFORMATION PRESENTATION AND COMPUTER-READABLE MEDIUM

(71) Applicant: Beijing Xiaomi Mobile Software Co., Ltd., Beijing (CN)

(72) Inventor: Qian WANG, Beijing (CN)

(21) Appl. No.: 15/338,542

(22) Filed: Oct. 31, 2016

(30) Foreign Application Priority Data
Mar. 29, 2016 (CN) 201610188938.X

(51) Int. Cl. H04W 12/08; H04M 1/67

(52) U.S. Cl. CPC H04W 12/08; H04M 1/67

(57) ABSTRACT

A method for presenting information in a terminal includes reading event information recorded by a predetermined application program installed on the terminal when an operating instruction for activating a screen of the terminal is detected, and displaying a current system time of the terminal and the event information on the screen simultaneously.

### CROSS-REFERENCE TO RELATED APPLICATION

This application claims priority to Chinese Patent Application No. 201610188938.X, filed Mar. 29, 2016, the entire contents of which are incorporated herein by reference.

### FIELD

The present disclosure generally relates to computer technology and, more particularly, to a method and device for information presentation and a computer-readable medium.

### BACKGROUND

In a wireless terminal, screen-lock is a means of preventing unintended operations. While the screen is locked, if a user activates the screen, the screen only displays the current time to the user. If the user wishes to see more information, the user has to unlock the screen to access the operating system interface for relevant information, or acquire the relevant information from a notification column by pulling it down. The operation of acquiring information is relatively complicated.

### SUMMARY

In accordance with the present disclosure, there is provided a method for presenting information in a terminal includes reading event information recorded by a predetermined application program installed on the terminal when an operating instruction for activating a screen of the terminal is detected, and displaying a current system time of the terminal and the event information on the screen simultaneously.

Also in accordance with the present disclosure, there is provided a terminal including a processor and a memory storing instructions that, when executed by the processor, cause the processor to read event information recorded by a predetermined application program installed on the terminal when an operating instruction for activating a screen of the terminal is detected, and display a current system time of the terminal and the event information on the screen simultaneously.

Also in accordance with the present disclosure, there is provided a non-transitory computer-readable storage medium having stored therein instructions that, when executed by a processor of a terminal, cause the terminal to read event information recorded by a predetermined application program installed on the terminal when an operating instruction for activating a screen of the terminal is detected, and display a current system time of the terminal and the event information on the screen simultaneously.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow diagram illustrating a method for information presentation according to an exemplary embodiment.

FIGS. 2-4 are diagrams illustrating the effect of information presentation according to exemplary embodiments.

FIG. 5 is a block diagram illustrating a device for information presentation according to an exemplary embodiment.

FIG. 6 is a block diagram illustrating an information obtaining module shown in FIG. 5 according to an exemplary embodiment.

FIG. 7 is a block diagram illustrating an information displaying module shown in FIG. 5 according to an exemplary embodiment.

FIG. 8 is a block diagram illustrating a device for information presentation according to another exemplary embodiment.

The specific embodiments of the present disclosure are shown with the figures above, and that will be described in further detail below. These figures and description are not for limiting the scope of the present disclosure in any way, but for illustrating the concept of the present disclosure for those of ordinary skill in the art by referring to the particular embodiments.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the disclosure. Instead, they are merely examples of apparatuses and methods consistent with aspects related to the invention as recited in the appended claims.

The technical solution provided in embodiments of the present disclosure can be applied in a terminal that can be an electronic device having a displaying function, such as, for example, a mobile phone or a tablet computer. It is easy to understand that the present disclosure can be applied in any mobile terminal having a processor and a displaying output device.

Exemplary methods for information presentation applied in a terminal are provided in embodiments of the present disclosure. One exemplary method includes reading, when an operating instruction for activating the terminal's screen is detected, event information recorded by a predetermined application program installed on the terminal; and displaying system time and the event information simultaneously. According to the present disclosure, a user can obtain the related event information without other operations after activating the screen. It is convenient for the user to query event information that the user is interested in, such as meeting schedule, information reminding event, and/or service information.

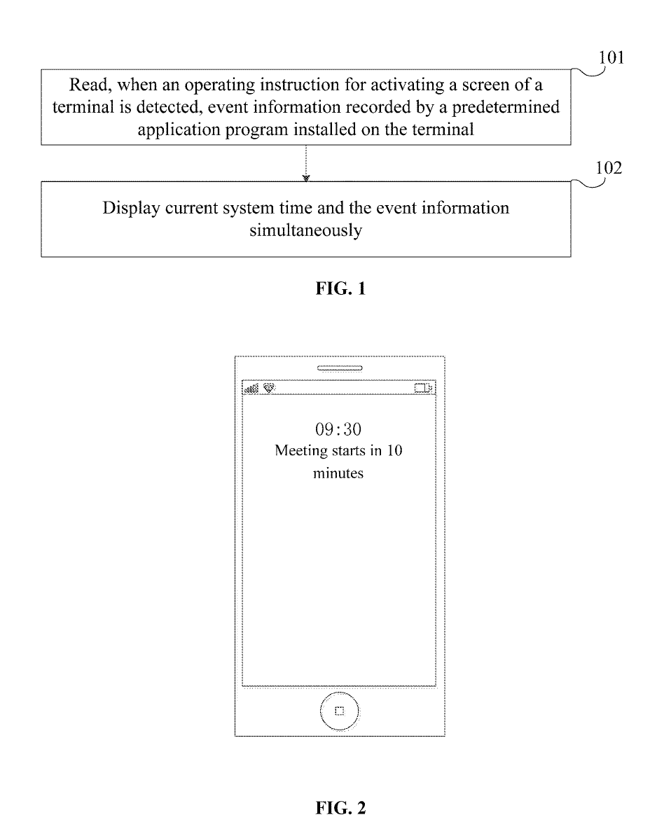

FIG. 1 is a flow chart illustrating a method for information presentation according to an exemplary embodiment. The method for information presentation can be implemented, for example, in a terminal having displaying function, such as a mobile phone. Referring to FIG. 1, at 101, when an operating instruction for activating the terminal's screen is detected, event information recorded by a predetermined application program installed on the terminal is read.

In some embodiments, the predetermined application program includes, for example, memo, mail, calendar, alarm clock, and/or a service-related application program. The service-related application can be an application providing a service to the user, such as a taxi reserving app or a shopping app. In some embodiments, the event information includes, for example, a meeting schedule, an information reminding event, and/or service information.

In some embodiments, reading the event information recorded by the predetermined application program installed on the terminal includes reading a reminding event recorded by the memo app installed on the terminal, reading a meeting schedule recorded by the mail app installed on the terminal, reading a reminding event and/or a meeting schedule recorded by the calendar app installed on the terminal, reading a clock alarm event recorded by the alarm clock app installed on the terminal, and/or reading a service-related application program installed on the terminal and obtaining an unfinished service information recorded by the service-related application program.

At 102, system time and the event information are simultaneously displayed. In some embodiments, displaying the event information includes processing the event information based on current system time and displaying the processed event information. In some embodiments, the event information includes a reminding event. In such embodiments, processing the event information based on the current system time includes determining a remaining time before the reminding event occurs, i.e., the remaining time until the reminding event, based on the current system time, and displaying the processed event information includes displaying and reminding the user about the remaining time before the reminding event. In some embodiments, the event information includes a meeting schedule. In such embodiments, processing the event information based on the current system time includes determining a remaining time before the time of the meeting based on the current system time, and displaying the processed event information includes displaying and reminding the user about the remaining time before the meeting. In some embodiments, the event information includes a clock alarm event. In such embodiments, processing the event information based on the current system time includes determining a remaining time before the time of the clock alarm based on the current system time, and displaying the processed event information includes displaying and reminding the user of the existence of the clock alarm. In some embodiments, the event information includes service information. In such embodiments, processing the event information based on the current system time includes determining a waiting time till the service is available based on the current system time, and displaying the processed event information includes displaying and reminding the user about the service information.

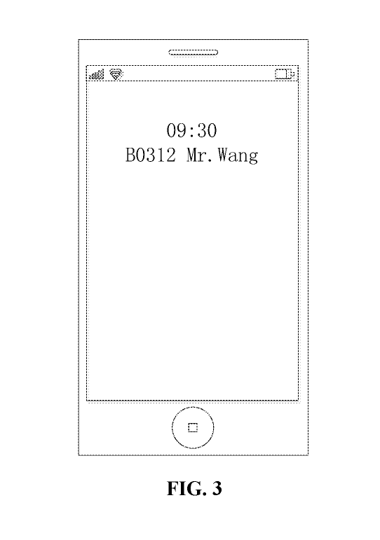

Exemplary methods consistent with the present disclosure will be further explained in connection with FIGS. 2-4, which show the screen of a terminal displaying information consistent with the present disclosure.

Specifically, FIG. 2 shows the screen displaying a reminder of a remaining time before a meeting. In this embodiment, a meeting schedule recorded by the calendar app installed on the terminal is read when an operating instruction for activating the terminal's screen is detected. A scheduled time of the meeting is extracted and the remaining time before the meeting is determined based on the current system time. Then, the current system time and the reminder of the remaining time before the meeting are simultaneously displayed when the screen lights up, as shown in FIG. 2, to remind the user that “Meeting starts in 10 minutes.” In some embodiments, a meeting topic in the recorded meeting schedule can also be extracted and a reminder of the meeting topic displayed simultaneously with the reminder.

FIG. 3 shows the screen displaying service information. In this embodiment, a service-related application program installed on the terminal is read when an operating instruction for activating the terminal's screen is detected. The service information is extracted. Then the current system time and the service information are simultaneously displayed when the screen lights up. The service information can include, for example, plate number information and driver information extracted from a taxi-calling application program, as shown in FIG. 3. In some embodiments, other service information can also be displayed, such as charging information, information about whether the fee is paid, information about estimated time of arrival of the driver, and/or information about a current location of the driver.

FIG. 4 shows the screen displaying a reminding event. In this embodiment, the memo application installed on the terminal is read when an operating instruction for activating the terminal's screen is detected. The reminding event recorded by the memo application is read. Then the current system time and the reminding event are simultaneously displayed when the screen lights up, as shown in FIG. 4. The reminding event can be, for example, “Today you should send a package to someone,” as shown in FIG. 4.

In the exemplary embodiments described above, event information recorded by one application program is read when an operating instruction for activating the terminal's screen is detected. In some embodiments, event information recorded by two or more application programs can be read and displayed simultaneously with the actual system time.

Exemplary devices consistent with the present disclosure that implement methods consistent with the present disclosure, such as one or more of the exemplary methods described above, are described below. A device according to the present disclosure can be a part of a terminal or an entire terminal, where the terminal can be an electronic device having a screen, such as a mobile phone. Further, the device can be implemented by software, hardware, or a combination thereof. Operations of the exemplary devices are similar to the exemplary methods described above, and thus detailed description thereof is omitted.

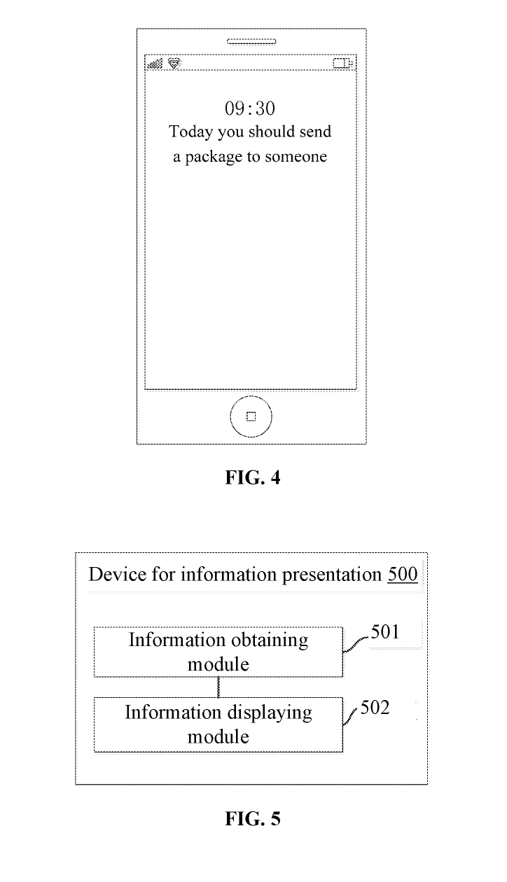

FIG. 5 is a block diagram illustrating a device 500 for information presentation according to an exemplary embodiment. As shown in FIG. 5, the device 500 includes an information obtaining module 501 and an information displaying module 502. The information obtaining module 501 is configured to read event information recorded by a predetermined application program installed on the terminal when an operating instruction for activating the terminal's screen is detected. The information displaying module 502 is configured to display a system time and the event information simultaneously. The predetermined application program includes, for example, a memo app, a mail app, a calendar app, an alarm clock app and/or a service-related application program. The event information includes, for example, a meeting schedule, an information reminding event, and/or service information.

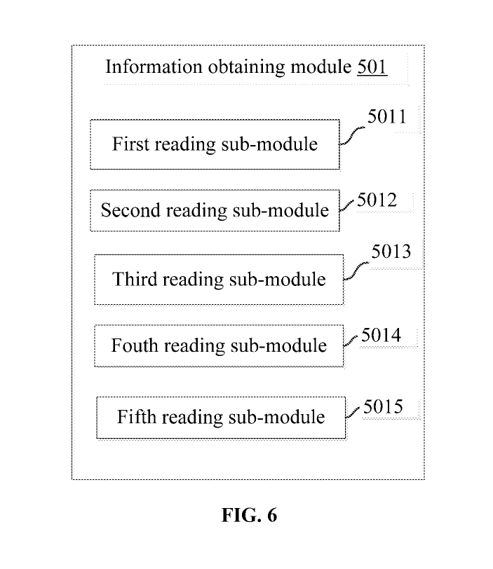

FIG. 6 is a block diagram showing an exemplary configuration of the information obtaining module 501. As shown in FIG. 6, the information obtaining module 501 includes at least one of a first reading sub-module 5011, a second reading sub-module 5012, a third reading sub-module 5013, a fourth reading sub-module 5014, and a fifth reading sub-module 5015. The first reading sub-module 5011 is configured to read a reminding event recorded by the memo app installed on the terminal. The second reading sub-module 5012 is configured to read a meeting schedule recorded by the mail app installed on the terminal. The third reading sub-module 5013 is configured to read a reminding event and/or a meeting schedule recorded by the calendar app installed on the terminal. The fourth reading sub-module 5014 is configured to read a clock alarm event recorded by the alarm clock app installed on the terminal. The fifth reading sub-module 5015 is configured to read a service-related application program installed on the terminal to obtain unfinished service information recorded by the service-related application program.

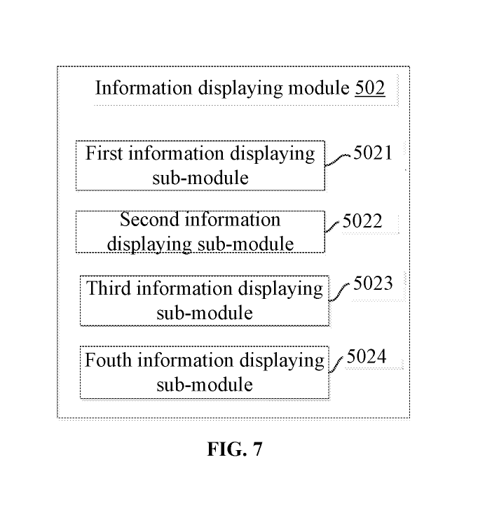

In some embodiments, the information displaying module 502 is further configured to process the event information based on the current system time and displaying the processed event information. In such embodiments, as shown in FIG. 7, the information displaying module 502 includes at least one of a first information displaying sub-module 5021, a second information displaying sub-module 5022, a third information displaying sub-module 5023, and a fourth information displaying sub-module 5024.

The first information displaying sub-module 5021 is configured to, when the event information is a reminding event, determine a remaining time before a reminding event based on the current system time, and display and remind a user about the remaining time before the reminding event.

The second information displaying sub-module 5022 is configured to, when the event information includes a meeting schedule, determine a remaining time before the meeting based on the current system time, and display and remind the user about the remaining time before the meeting.

The third information displaying sub-module 5023 is configured to, when the event information includes a clock alarm event, determine a remaining time before the clock alarm based on the current system time, then display and remind the user the existence of the clock alarm.

The fourth information displaying sub-module 5024 is configured to, when the event information includes service information, determine a waiting time till the service is available based on the current system time, and display and remind the user about the service information.

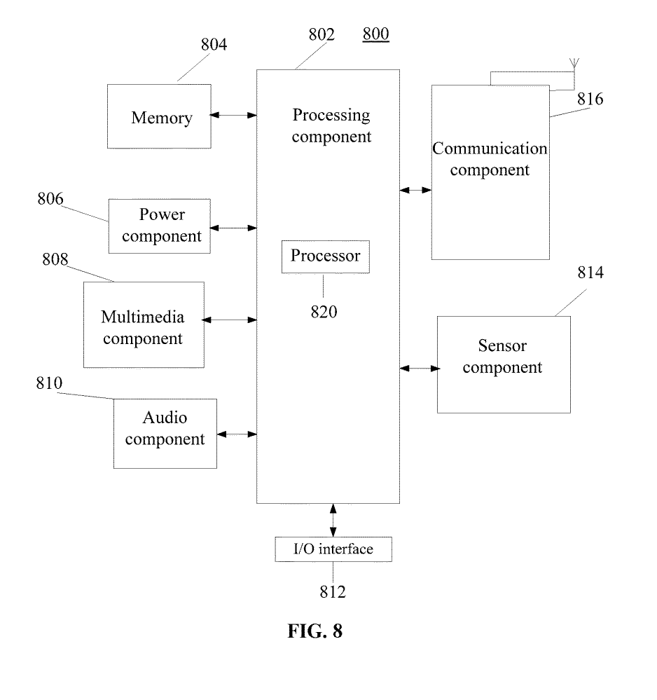

FIG. 8 is a block diagram illustrating a device 800 for information presentation according to an exemplary embodiment. The device 800 can be a terminal, such as a mobile phone, a tablet computer, or a smart.

Refer to FIG. 8, the device 800 includes one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 may include a power management system, one or more power sources, and any other components associated with the generation, management, and distribution of power for the device 800.

The multimedia component 808 includes a screen providing an output interface between the device 800 and the user. In some embodiments, the screen may include a liquid crystal display (LCD) or a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 800 is in an operation mode, such as a photographing mode or a video mode. Each of the front camera and the rear camera may be a fixed optical lens system or have optical focusing and zooming capability.

The audio component 810 is configured to output and/or input audio signals. For example, the audio component 810 includes a microphone configured to receive an external audio signal when the device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, the peripheral interface modules being, for example, a keyboard, a click wheel, buttons, and the like. The buttons may include, but are not limited to, a home button, a volume button, a starting button, and a locking button.

The sensor component 814 includes one or more sensors to provide status assessments of various aspects of the device 800. For instance, the sensor component 814 may detect an open/closed status of the device 800, relative positioning of components (e.g., the display and the keypad, of the device 800), a change in position of the device 800 or a component of the device 800, a presence or absence of user contact with the device 800, an orientation or an acceleration/deceleration of the device 800, and a change in temperature of the device 800. The sensor component 814 may include a proximity sensor configured to detect the presence of a nearby object without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G, 3G or 4G or a combination thereof. In an exemplary embodiment, the communication component 816 receives a broadcast signal or broadcast associated information from an external broadcast management system via a broadcast channel. In an exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, or another technology.

In exemplary embodiments, the device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the device 800, for performing the above-described methods. For example, the non-transitory computer-readable storage medium may be a ROM, a RAM, a CD-ROM, a magnetic tape, a floppy disc, an optical data storage device, or the like.

A non-transitory computer readable storage medium having stored therein instructions that, when executed by the processor of the device 800, causes the device 800 to perform the above described method for presenting information.

According to the present disclosure, a user can obtain related event information without other operations after activating a terminal screen. It is convenient for the user to query some event information that the user is interested in, such as meeting schedule, information reminding event, and/or service information.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for presenting information in a terminal, comprising:
reading, when an operating instruction for activating a screen of the terminal is detected, event information recorded by a predetermined application program installed on the terminal; and
displaying a current system time of the terminal and the event information on the screen simultaneously.

2. The method of claim 1, wherein reading the event information from the predetermined application program includes reading event information from at least one of a memo application program, a mail application program, a calendar application program, an alarm clock application program, or a service-oriented application program.

3. The method of claim 1, wherein reading the event information includes reading at least one of a meeting schedule, an information reminding event, or service information.

4. The method of claim 1, wherein reading the event information recorded by the predetermined application program installed on the terminal includes at least one of:
reading a reminding event recorded by a memo application program installed on the terminal;
reading a meeting schedule recorded by a mail application program installed on the terminal;
reading at least one of a reminding event or a meeting schedule recorded by a calendar application program installed on the terminal;
reading a clock alarm event recorded by a alarm clock application program installed on the terminal; or
reading a service-related application program installed on the terminal, and obtaining unfinished service information recorded by the service-related application program.

5. The method of claim 1, wherein displaying the event information includes:
processing the event information based on the current system time and displaying the processed event information.

6. The method of claim 5, wherein processing the event information based on the current system time and displaying the processed event information include at least one of:
determining, when the event information includes a reminding event, a remaining time before the reminding event based on the current system time, and displaying and reminding a user about the remaining time before the reminding event;
determining, when the event information includes a meeting schedule, a remaining time before the meeting based on the current system time, and displaying and reminding the user about the remaining time before the meeting;
determining, when the event information includes a clock alarm event, a remaining time before the clock alarm based on the current system time, and displaying and reminding the user existence of the clock alarm; or
determining, when the event information includes service information for a service, a waiting time till the service is available based on the current system time, and displaying and reminding the user about the service information.

7. A terminal comprising:
a processor; and
a memory storing instructions that, when executed by the processor, cause the processor to:
read, when an operating instruction for activating a screen of the terminal is detected, event information recorded by a predetermined application program installed on the terminal; and
display a current system time of the terminal and the event information on the screen simultaneously.

8. The terminal of claim 7, wherein the predetermined application program includes at least one of a memo application program, a mail application program, a calendar application program, an alarm clock application program, or a service-related application program.

9. The terminal of claim 7, wherein the event information includes at least one of a meeting schedule, an information reminding event, or service information.

10. The device of claim 7, wherein the instructions further cause the processor to:
read a reminding event recorded by a memo application program installed on the terminal;
read a meeting schedule recorded by a mail application program installed on the terminal;
read at least one of a reminding event or a meeting schedule recorded by a calendar application program installed on the terminal;
read a clock alarm event recorded by a alarm clock application program installed on the terminal; or
read a service-related application program installed on the terminal, and obtaining unfinished service information recorded by the service-related application program.

11. The device of claim 7, wherein the instructions further cause the processor to process the event information based on the current system time and display the processed event information.

12. The device of claim 11, wherein the instructions further cause the processor to:
determine, when the event information includes a reminding event, a remaining time before the reminding event based on the current system time, and display and remind a user about the remaining time before the reminding event;
determine, when the event information includes a meeting schedule, a remaining time before the meeting based on the current system time, and display and remind the user about the remaining time before the meeting;
determine, when the event information includes a clock alarm event, a remaining time before the clock alarm based on the current system time, and display and remind the user existence of the clock alarm; or
determine, when the event information includes service information for a service, a waiting time till the service is available based on the current system time, and display and remind the user about the service information.

13. A non-transitory computer-readable storage medium having stored therein instructions that, when executed by a processor of a terminal, cause the terminal to:
read, when an operating instruction for activating a screen of the terminal is detected, event information recorded by a predetermined application program installed on the terminal; and
display a current system time of the terminal and the event information on the screen simultaneously.
